(19) United States
(12) Patent Application Publication
(10) Pub. No.: US 2020/0364913 A1
(43) Pub. Date: Nov. 19, 2020

(54) USER GUIDED SEGMENTATION NETWORK

(71) Applicant: Matterport, Inc., Sunnyvale, CA (US)

(72) Inventor: Gary Bradski, Palo Alto, CA (US)

(73) Assignee: Matterport, Inc., Sunnyvale, CA (US)

(21) Appl. No.: 16/411,657

(22) Filed: May 14, 2019

(51) Int. Cl. G06T 11/60; G06T 7/11; G06T 7/194; G06K 9/62

(52) U.S. Cl. CPC G06T 11/60; G06T 7/11; G06T 7/194; G06K 9/6254; G06T 2207/20021; G06T 2207/20081; G06T 2207/20084; G06T 2200/24; G06K 9/6263

(57) ABSTRACT

Systems and methods for user guided iterative frame segmentation are disclosed herein. A disclosed method includes providing a ground truth segmentation, synthesizing a failed segmentation from the ground truth segmentation, synthesizing a correction input for the failed segmentation using the ground truth segmentation, and conducting a supervised training routine for the segmentation network. The routine uses the failed segmentation and correction input as a segmentation network input and the ground truth segmentation as a supervisory output.

### BACKGROUND

Segmentation involves selecting a portion of an image to the exclusion of the remainder. Image editing tools generally include features such as click and drag selection boxes, free hand “lasso” selectors, and adjustable cropping boxes to allow for the manual segmentation of an image. Certain image editors also include automated segmentation features such as “magic wands” which automate selection of regions based on a selected sample using an analysis of texture information in the image, and “intelligent scissors” which conduct the same action but on the bases of edge contrast information in the image. Magic wands and intelligent scissor tools have a long history of integration with image editing tools and have been available in consumer-grade image editing software dating back to at least 1990. More recent developments in segmentation tools include those using an evaluation of energy distributions of the image such as the “Graph Cut” approach disclosed in Y. Boykov et al., Interactive Graph Cuts for Optimal Boundary & Region Segmentation of Objects in N-D Images, Proceedings of ICCV, vol. I, p. 105, Vancouver, Canada, July 2001.

Recent development in large scale image segmentation has been driven by the need to extract information from images available to machine intelligence algorithms studying images on the Internet. The most common tool used for this kind of image analysis is a convolutional neural network (CNN). A CNN is a specific example an artificial neural networks (ANNs). CNNs involve the convolution of an input image with a set of filters that are “slid around” the image file to test for a reaction from a given filter. The filters serve in place of the variable weights in the layers of a traditional ANN. These networks can be trained via supervised learning in which a large mount of training data entries, each of which includes a ground truth solution to a segmentation problem along with the corresponding raw image, are fed into the network until the network is ultimately able to execute analogous segmentation problems using only raw image data. The training process involves iteratively adjusting the weights of the network (e.g., filter values in the case of CNNs).

One example of a segmentation problem that will be used throughout this disclosure is segmenting the foreground of an image from the background. Segmenting can involve generating a hard mask, which labels each pixel using a one or a zero to indicate if it is part of the foreground or background, or generating an alpha mask which labels each pixel using a value from zero to one which allows for portions of the background to appear through a foreground pixel if the foreground is moved to a different background. FIG. 1 includes a portrait 100 which is being segmented by a CNN 120 into a hard mask 110. The CNN 120 includes an encoder section 121 and a decoder section 122. The CNN operates on sub-units of the input image which are equal in size to the input size of the CNN. In the illustrated case, CNN 120 generates output 111 using input 101. Input 101 can be a grey scale or RGB encoding 102 in which each pixel value is represented by one or more numerical values used to render the image. Output 111 can be a hard mask encoding 112 in which each element corresponds to either a 1 or a 0. As illustrated, the hard mask values can be set to 1 in the foreground and 0 in the background. Subsequently, when the hard mask 112 is dot multiplied by the image encoding 102, all the background pixels will be set to zero and all the foreground pixels will retain their original values in the image encoding 102. As such, the hard mask can be used to segment the foreground of the original image from the background.

### SUMMARY

This disclosure is directed to user guided segmentation networks. The networks can be directed graph function approximators with adjustable internal variables that affect the output generated from a given input. The adjustable internal variables can be adjusted using back-propagation and a supervised learning training routine. The networks can be artificial neural networks (ANNs) such as convolutional neural networks (CNNs). The disclosure involves segmentation networks that take in a failed segmentation input along with user provided hints or “seeds” and output a segmentation that segments an image according to what the user desired. The seeds can be correction inputs provided with respect to the failed segmentation.

As used herein, outputting a segmentation or outputting a segmented image is meant to include producing any output that can be useful for a person that wants to select only a portion of an image to the exclusion of the remainder. For example, the output could be a hard mask or an alpha mask of the input. As another example, the output could be a set of original image values for the image in the segmented region with all other image values set to a fixed value. Returning to the example of FIG. 1, the CNN could have alternatively produced an output in which the value of the foreground pixels were those of the original image while the background pixel values were set to zero. The fixed value could be a one, a zero, or any value indicative of a transparent pixel such as those used to render transparency in an image file. Although the example of segmenting a foreground from a background will be used throughout this disclosure, the approaches disclosed herein are applicable to numerous segmentation and image editing tasks and should not be limited to that application.

Fully automated segmentation networks such as the one discussed in FIG. 1 above exhibit certain drawbacks in that a “good” segmentation is often subjective. Blur and other artifacts in the underlying image create a problem which has no true solution and it is often up to the artistic license of a skilled image processing professional to determine how exactly the image should be segmented. As such, benefits accrue to approaches in which a human is provided with the ability to quickly and iteratively provide updates to a previously provided segmentation. Furthermore, iterative segmentation allows a segmentation system to leverage the work done by prior steps to improve its performance by focusing on the boarder area of the input and then tuning the more discriminating aspects of its algorithm as the “correct” answer approaches in sequence.

Considering the above, specific embodiments disclosed herein relate to a network that takes in both a failed segmentation and a correction input to that failed segmentation and outputs an updated segmentation based thereon. In certain approaches, the failed segmentation can be considered to have “failed” strictly because it is subject to further user adjustment, not because it has failed any objective measure of performance. In other words, the segmentation can be adjusted based solely on a desire to adjust the subjective appearance of the segmentation. Regardless, the approaches disclosed herein provide an image processing tool with an iteratively guided segmentation network that can improve itself with time and learn the subjective preferences of a given user while continuously maintaining flexibility for further adjustments given the artistic needs of any given segmentation process. Training data can be harvested from the iterative segmentation process to guide this process.

Furthermore, while ANNs and associated approaches have unlocked entirely new areas of human technical endeavor and have led to advancements in fields such as image and speech recognition, they are often limited by a lack of access to solid training data. ANNs are often trained using a supervised learning approach in which the network must be fed tagged training data with one portion of the training data set being a network input and one portion of the training data set being a ground truth inference that should be drawn from that input. The ground truth inference can be referred to as the supervisor of the training data set. However, obtaining large amounts of such data sets can be difficult.

Considering the above, specific embodiments disclosed herein relate to generating training data for a network for user guided segmentation. Specific embodiments involve generating a set of training data for such a network solely based on a ground truth segmentation input. The remainder of the training data set can be generated by a perturbation engine and a user input synthesis engine. The perturbation engine and user input synthesis engines can both be configured to generate the complete training data set using only the ground truth segmentation as an input. However, both engines can also operate with the original image as an additional input, and the user input synthesis engine can also operate with the output of the perturbation engine as an additional input.

The perturbation engine and user input synthesis engine can be powered by random processes. The perturbation engine can be configured to introduce randomized disruptions in the boundary between a segmentation and the remainder of the image to create a failed segmentation. The perturbation engine can introduce errors to the ground truth segmentation using random processes. Alternatively, the perturbation engine can utilize a traditional closed form segmentation solution such as a magic wand, or energy distribution-based segmentation tool, attempting to generate a good faith segmentation from the raw image file on which the ground trust segmentation was based. The user input synthesis engine can introduce synthesized corrections to the failed segmentation using randomized processes and the ground truth segmentation.

Using approaches in the detailed disclosure below, the training data, as generated from the ground trust segmentation, will effectively train the network to conduct user guided segmentation without having to harvest large amounts of training data from actual human inputs, and at the same time will learn to solve the problem of iterative human guided segmentation as opposed to learning the characteristics of the training data generator.

In a specific embodiment of the invention, a system is provided. The system includes a display driver for displaying the image and an image segmentation on a display with the image segmentation overlaid on the image. The system also includes a user interface for accepting a correction input. The system also includes a segmentation network configured to: (i) accept the image segmentation and the correction input; and (ii) output a corrected segmentation from the image segmentation and the correction input. The system also includes a trainer configured to save the corrected segmentation, synthesize training data, and conduct a training routine for the segmentation network using the synthesized training data and the corrected segmentation.

In a specific embodiment of the invention, a method is provided. The method includes displaying an image and an image segmentation on a display with the image segmentation overlaid on the image, accepting a correction input from a user interface, applying the image segmentation and the correction input to a segmentation network, generating a corrected segmentation using the segmentation network based on the application of the image segmentation and the correction input to the segmentation network, and saving the corrected segmentation. The method also includes synthesizing training data for the segmentation network using the corrected segmentation, the image segmentation, and the correction input. The method also includes training the segmentation network using the training data

In a specific embodiment of the invention, a method is provided. The method includes providing a ground truth segmentation, synthesizing a failed segmentation from the ground truth segmentation, synthesizing a correction input for the failed segmentation using the ground truth segmentation, and conducting a supervised training routine for the segmentation network. The routine uses the failed segmentation and correction input as a segmentation network input and the ground truth segmentation as a supervisory output.

### BRIEF DESCRIPTION OF THE DRAWINGS

FIG. 1 is a data flow diagram illustrating the operation of an automated segmentation network in accordance the related art.

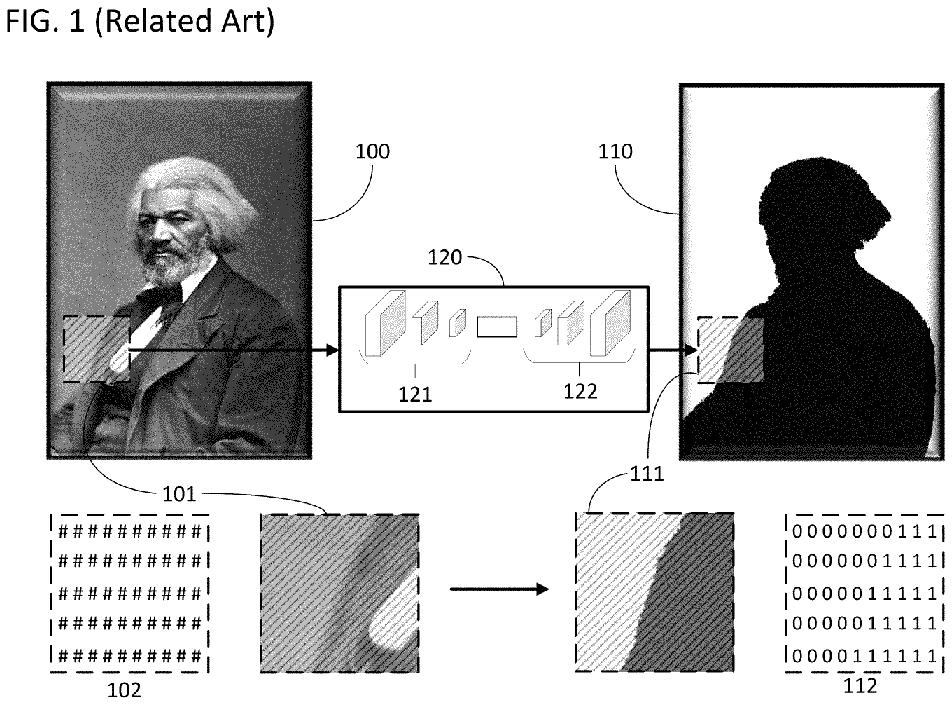

FIG. 2 is a flow chart for a set of methods and systems for conducting a segmentation of an image using a user guided segmentation network in accordance with specific embodiments of the invention disclosed herein.

FIG. 3 is flow chart for a set of methods for generating training data for a human-assisted segmentation network in accordance with specific embodiments of the invention disclosed herein.

FIG. 4 is a flow chart for a set of methods and systems for harvesting training data for a user guided segmentation network in accordance with specific embodiments of the invention disclosed herein.

FIG. 5 illustrates a simple mark input for a user guided segmentation network in accordance with specific embodiments of the invention disclosed herein.

FIG. 6 illustrates a directed mark input for a user guided segmentation network in accordance with specific embodiments of the invention disclosed herein.

FIG. 7 illustrates a simple click input for a user guided segmentation network in accordance with specific embodiments of the invention disclosed herein.

### DETAILED DESCRIPTION

Specific methods and systems associated with user-guided segmentation networks in accordance with the summary above are provided in this section. The methods and systems disclosed in this section are nonlimiting embodiments of the invention, are provided for explanatory purposes only, and should not be used to constrict the full scope of the invention.

This section includes a description of specific embodiments of the invention in which a network takes in both a failed segmentation and a correction input to that failed segmentation and outputs an updated segmentation based thereon. This section also includes a description of specific embodiments of the invention in which such a network is trained and in which training data is synthesized. The training data can be synthesized solely based on a ground truth segmentation of an image. The training data can be synthesized by a perturbation engine and a user input synthesis engine, examples of which will be described below. In specific embodiments, the training data can in combination, or in the alternative, be harvested from usage of the system in the ordinary course of operation.

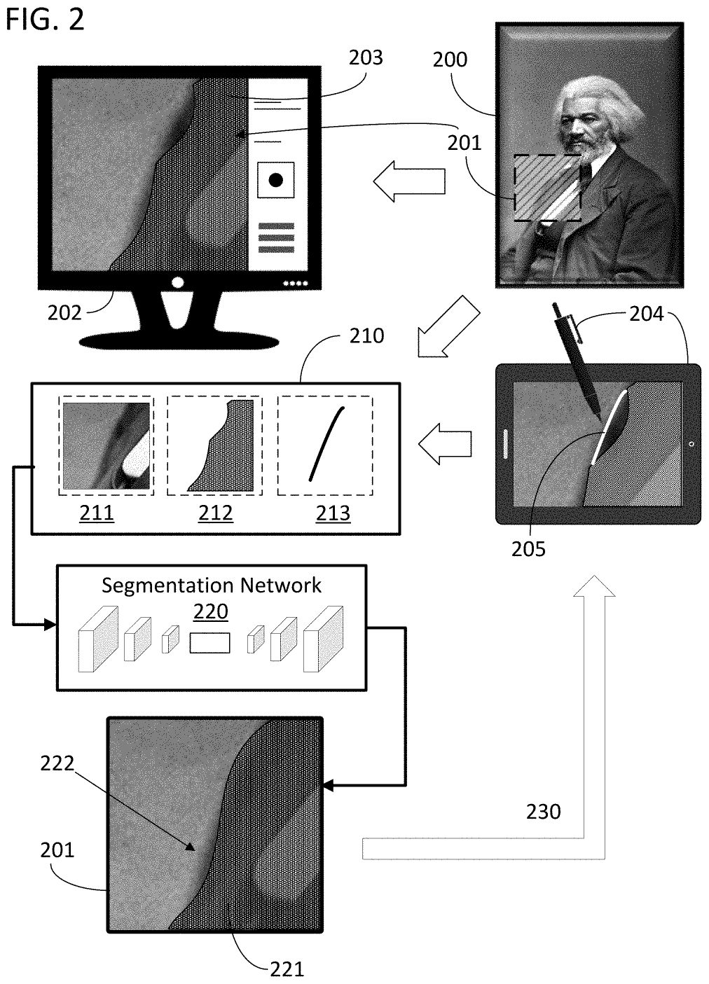

Specific embodiments of the invention include a system for the segmentation of an image using a user guided segmentation network. The segmentation network can be integrated with an image editor. The image editor may operate on independent images in isolation or still images extracted from a stream of images such as frames from a video feed. The image editor can enable a user to trigger an initial segmentation of the image. The image editor may also include a feature to focus the user onto on operable area of the image as determined by the input size of the segmentation network that is integrated with the image editor. In the example of FIG. 2, the user could be directed to slide a selection box 201 around the image to operate on a single sub-unit of the image where the selection box size was set equal to the allowable size of the input of the segmentation network in pixels. In the alternative, the image editor could automatically assign the positions of a set of selection boxes as part of the initial segmentation such that the boxes, or other closed shapes, were centered along the boundary of the initial segmentation.

An initial segmentation can be conducted by a traditional method such as a level-set, texture based, edge detector based, or energy based closed form algorithmic solution. In certain approaches, the initial segmentation will be guided by a “seed” provided by the user such as one or more closed shapes drawn by the user on the image, one or more lines drawn by the user on the image or by one or more clicks by the user on the image. The initial segmentation can also be conducted by the segmentation network. In specific approaches the seeds selected by the user can be used by the segmentation network to produce the initial segmentation. The portion of the image which is to be segmented and/or the seeds for the segmentation can be selected by the user using a digital pen, mouse, touch display, or any other input device.

The initial segmentation can be iterated using user inputs. These user inputs can be referred to as correction inputs and the initial segmentation can be referred to as a failed segmentation. However, as mentioned above, the initial segmentation can be considered to have “failed” and require “correction” only to the extent that is does not meet the subjective requirements of the user that is guiding the segmentation, as opposed to failing an objective metric as to the accuracy of a segmentation. In specific approaches in which the initial segmentation is guided by user input, the same class of user inputs can be provided as the correction inputs. However, the first set of seeds may have been used by a traditional closed form segmentation algorithm while the second set of user inputs can be used by a user guided segmentation network that requires an initial segmentation as an input.

FIG. 2 illustrates a block diagram that can be used to explain a specific example of the segmentation systems described in the previous paragraphs. In the illustrated example, the white arrows indicate data dependencies. The operation of the segmentation system is described with reference to image 200 from which a user is guiding the segmentation of the foreground. The system can include a display driver, illustrated with reference to display 202, for displaying at least a portion of the image 201 and an image segmentation 203. In FIG. 2, the portion of the image 201 is shown with the image segmentation 203 overlaid on the image. A user interface can then be used for accepting a correction input from a user. In the illustrated case, the user interface is a digital pen and tablet 204 where the tablet includes a display and sensor for detecting the location of the digital pen. A user is thereby enabled to provide a correction input directly on a rendering of the image with the initial segmentation overlain thereon. In the illustrated case, the correction input is a line 205 drawn using the digital pen which indicates approximately where the user believes the segmentation boundary should have been provided. Numerous alternative forms of the correction input are provided below.

In specific embodiments of the invention, an initial segmentation can be provided to a segmentation network in combination with a correction input provided by a user with respect to that initial segmentation. The original image can also be included with the data set provided to the segmentation network. In the illustrated case, the segmentation network input 210 includes the data values of the original image 211, the data values of the initial segmentation 212, and the data values of the correction input 213. In specific embodiments two or more of the three data elements mentioned above can be transformed into the same space such that the data elements for a single input tensor that can be applied to a segmentation network. The size of the portion of the input image that the segmentation system allows a user to work with at a given time can be set in part by the output of this transform as the resulting tensor may have larger dimensions that an array of pixels taken from the image. Various kinds of transforms and hashing algorithms can be applied to combine and properly format the input tensor for the segmentation network. However, in certain approaches, the input will have the same dimensions as the input image pixel matrix as all three data elements are naturally aligned with the input image and can be combined into an actionable input tensor without modifying the dimensions of the input image pixel matrix.

In specific embodiments of the invention, a user guided segmentation network generates a segmentation from an input segmentation and a user correction input. The segmentation network can be configured to accept the image segmentation and the correction input. The segmentation network can be a CNN with a set of filter value that can be altered through a training routine. The segmentation network can be configured to accept the aforementioned data values in the sense that it accepts an input tensor of a given size and conducts mathematical operations on those data values. For example, the first layer of the segmentation network could require the input tensor to be divided into four parts of 50 data units by 50 data units that will undergo convolution operations with a set of four different 10 data unit by 10 data unit filters. In this example, the segmentation network is configured to accept the data in the form of a 100 data unit by 100 data unit two-dimensional tensor. The segmentation network can then generate an image segmentation using any number of convolutional layers and fully connected layers.

In FIG. 2, segmentation network 220 is configured to accept the data from data set 210 and output segmentation 221. As illustrated, output segmentation 221 is overlain on image 201 and output segmentation 221 is a more accurate segmentation of the foreground of the image with specific respect to the region of the image which correction input 205 was provided. In accordance with specific embodiments of the invention, the user guided segmentation process is iterative and may involve an iteration loop path 230. As such, the display driver can again display the image with a segmentation overlain thereon (with the segmentation in this case being corrected segmentation 221) for the user to provide a second correction input via user interface 204. The corrected segmentation 221 and the second correction input could then be sent through the segmentation network 220 to produce another segmentation output. The process can continue to iterate until the user is satisfied with the result. As shown, image 201 still includes a region 222 which could potentially be considered either part of the foreground or a blurred region of the background. The segmentation of that portion of the image does not have an objective solution and the proper outcome relies on the subjective desires of the user. However, using certain embodiments of the invention that will be described below, the segmentation network can learn the idiosyncratic subjective interests of a particular operator and assist them in reaching a desired segmentation with fewer iterations.

In specific embodiments of the present invention, a training data generator is applied to generate training data for a user guided segmentation network. Returning to the example of FIG. 2, those of ordinary skill in the art will recognize the segmentation network 220 will need to be trained before it is capable of generating actionable inferences from a set of input data. However, as part of the input data set are the seeds, or correction inputs, 213 that are taken from human input. Segmentation networks can require a large volume of data to be properly trained. Accordingly, a training data generator can be used to synthesize the human data required to train the segmentation network. In specific embodiments of the present invention, a training data generator will be able to generate both the seeds and the initial “failed” segmentations from a ground truth segmentation. The complete data set for a supervised learning system will then include the failed segmentation and the seeds as inputs, and the ground truth segmentation as the supervisor. The difference between the output of the segmentation network, in response to the synthesized failed segmentation and the synthesized seeds or correction inputs, and the ground truth segmentation can be applied to a loss function to adjust the weights of the segmentation network.

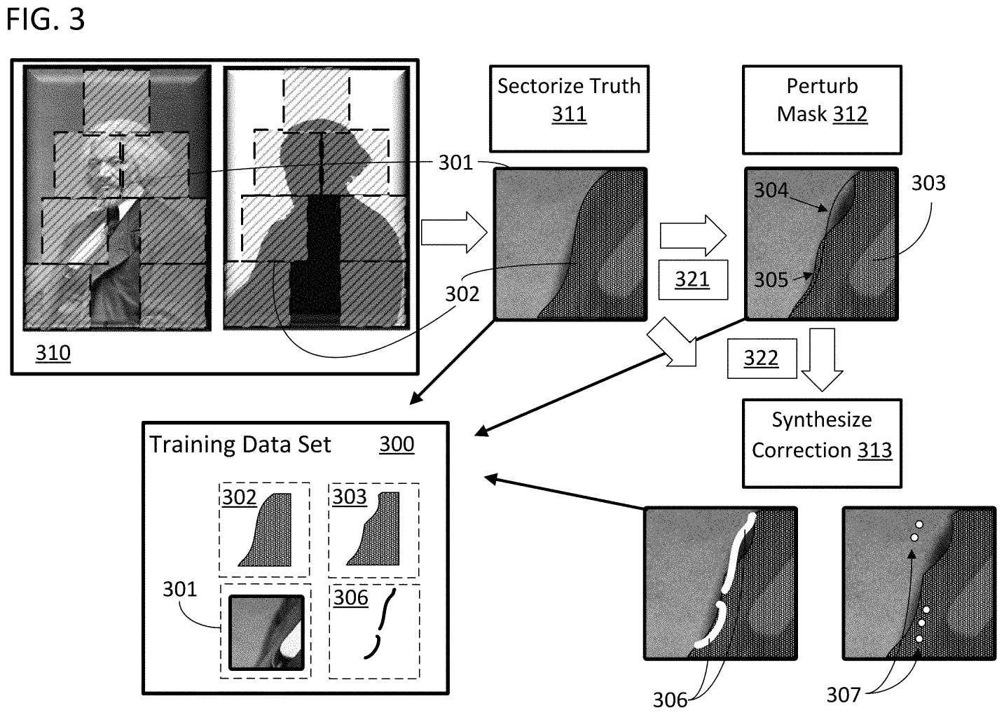

FIG. 3 illustrates a flow chart that can be used to describe a set of methods and systems for generating training data for a user-guided segmentation network. In the illustrated example, the white arrows indicate data dependencies. As seen, all that is required for generating the complete training data set 300 is a ground truth segmentation input 310. In the illustrated embodiment, the ground truth segmentation input includes the raw image file and a hard mask. However, as mentioned in the summary above, the same approach can be applied if the ground truth segmentation included an alpha mask.

The ground truth segmentation can first be sectorized if it is larger than the input size of the network that is to be trained using training data set 300. The step of sectorizing the ground truth segmentation can be optimized to only select portions of the ground truth that are in the general vicinity of where the segmentation will occur. To determine where these regions are located, a low fidelity or rough-cut segmentation tool can be used to find the general vicinity of the segmentation and the sectors can be positioned to straddle the located boundary. As illustrated, the ground truth segmentation 310 has been sectorized into sub-units that include sub-unit 301. The sub-unit includes information from both the segmentation and the original image file. As illustrated, sub-unit 301 includes a shaded overlay 302 identifying the location of the ground truth segmentation on the original image.

The flow chart continues with a step 312 of perturbing the ground truth segmentation to create a synthesized failed segmentation 303. The perturbations can be generated by a perturbation engine 321. The perturbation engine can utilize only the mask of the ground truth segmentation, or it can utilize both the mask and the original image. The perturbation engine 321 can include a randomized process and can scale, dilate, or expand the curves of the mask to synthesize failed segmentation 303. The perturbation engine can also use randomized grow and shrink routines to expand the mask in certain areas and/or dilate the mask in certain areas. In a specific embodiment, the perturbation engine can decompose a border of the mask from the ground truth segmentation into a set of quadratic Bezier curves and randomly alter the position of the anchor points of the curve according to a probability distribution either inward or outward form the center the masked area. The variance of the distribution can likewise be selected stochastically using the random processes of the perturbation engine across the set of anchor points. The order and length of the Bezier curves can also be stochastically generated during the decomposition process. In specific approaches, the decomposition process itself can be a low fidelity process to thereby inject errors into the mask. As shown, the resulting synthesized failed segmentation 303 may include areas that are underinclusive such as failed mask coverage region 304, and areas that are overinclusive such as failed mask exclusion region 305. The synthesized failed segmentation 303 can then be used by a user input synthesis engine 322 to generate synthesized correction input for training data set 300. Further approaches for generating the synthesized failed segmentation are discussed below.

The flow chart continues with a step of synthesizing correction inputs 313. The correction inputs can be synthesized using a correction synthesis engine 322. The characteristics of the synthesis engine can be set based on what type of correction inputs will be allowed for use with the network that is being trained using training data set 300. For example, the correction inputs could be click selections, scribbles, lines, click and drag specified polygons, double taps, swipes, and any other input that would allow a user to provide information to the system regarding how a mask should be corrected. In particular, in the case where a mask is an alpha mask, the inputs could include the manual specification of an alpha value from zero to one for a pixel or group of pixels along with an input identifying those pixels. Two potential sets of correction inputs are illustrated in FIG. 3. A set of lines 306 and a set of clicks 307. The lines 306 could be drawn by a digital pen along what a user would have considered the proper mask border. The clicks 307 can be selections of perceived failed mask regions 304 or failed mask exclusion regions 305. The synthesis correction engine can generate these corrections using random processes. In approaches in which the synthesis correction engine has access to both the mask and synthesized failed mask, the correction engine can create lines along the border of the ground truth mask with random perturbations, or randomly generate click points in an area specified by a delta between the ground truth mask and the failed mask. More specific approaches for generating the correction data will be described below in addition to transforms that can be applied to the correction data. Further approaches for generating the correction data are discussed below.

Training data set 300 can include the ground truth segmentation mask 302, or the entire ground truth segmentation 310 as the supervisor for a round of training. Training data set 300 can also include a failed segmentation 303, a correction input 306, and the sector of the original image encoding 304 as the network inputs for the training round. The loss function for the training round can operate based on a delta between the ground truth segmentation mask 302 and an output corrected mask generated by the network in response to the above-mentioned inputs. The same supervisor can be used for any number of training rounds so long as different correction inputs and failed segmentations are applied as inputs during those training rounds. However, the use of different supervisors may mitigation the tendency of the network to learn the characteristics of the perturbation engine and correction synthesis engine as opposed to learning how to improve segmentations using user input. Furthermore, perturbation engine 321 and correction synthesis engine 322 can be augmented by, or replaced with, one or more generative adversarial networks that are used to generate training data and prevent the network from overtraining on the underlying random processes of the engines.

In specific embodiments of the invention, a corrected segmentation generated through a user guided segmentation process in accordance with the approaches discussed above will be harvested by a trainer and used to improve the performance of the segmentation network used in that initial process. The trainer can be integrated with an image processing tool. The trainer can be configured to save the corrected segmentation generated by a user, synthesize training data, and conduct a training routine for the segmentation network using the synthesized training data and the corrected segmentation. The corrected segmentation can be the final result of the iterative loop described with reference to loop path 230 in FIG. 2. The training data can be synthesized using the approaches described with reference to training data set 300 in FIG. 3 where the corrected segmentation used as the ground truth segmentation 302 to synthesize the training data. A large set of training data can be synthesized to create multiple training data sets to run multiple training sessions. In specific approaches, the user input synthesis engine can base the correction inputs used to generate the corrected segmentation as the basis for synthesizing the additional correction inputs.

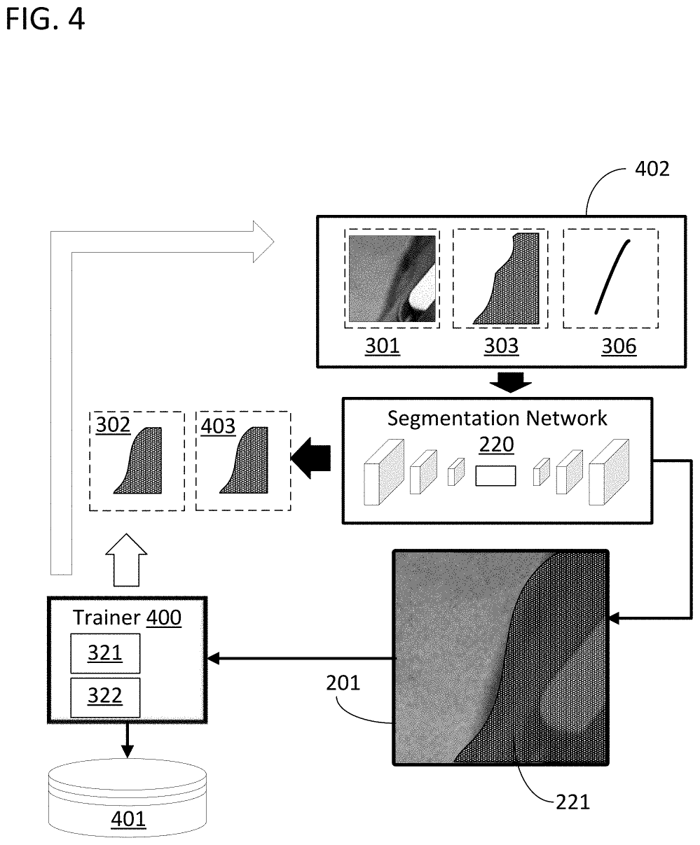

FIG. 4 provides a flow chart for a set of methods and systems for harvesting training data and running a training routine for a user guided segmentation network in accordance with specific embodiments of the invention disclosed above. FIG. 4 illustrates segmentation network 220 initially producing corrected segmentation 221. The segmentation can be the corrected segmentation 221 disclosed above with reference to FIG. 2. This portion of the flow chart is illustrated using thin black arrows. In this example, segmentation 221 will have been produced using user guidance in accordance with the subjective interests of the user guiding the segmentation. Subsequently, a trainer 400 can store the corrected segmentation 221 in a memory 401 to use as the ground truth supervisory output 302 for a training routine.

Trainer 400 can synthesize additional training data 402 along with providing the supervisory output 302 using the corrected segmentation 221. This portion of the flow chart is illustrated using thick white arrows. The trainer can use a perturbation 321 and a user input synthesis engine 322 to produce values for the training data 402 using similar approaches to those mentioned above with respect to FIG. 3. The trainer 400 can also be configured to save the correction inputs that went into generating corrected segmentation 221. Since corrected segmentation 221 may have been generated via multiple iterations there may be multiple sets of correction inputs saved. This collection of saved correction inputs can then be used to power user input synthesis engine 322. For example, random variants of the saved correction inputs produced in light of the original image can be used as the synthesized correction inputs 306.

Trainer 400 can subsequently conduct a training routine for the segmentation network using the synthesized training data 402 as an input to the segmentation network 220 and the corrected segmentation 221 as the ground truth supervisory output 302. This portion of the flow chart is illustrated using thick black arrows. In response to the synthesized training data 402, segmentation network 220 will produce an output segmentation 403. A comparison of output segmentation 403 and ground truth supervisory output 302 can then be used to generate a loss function value for adjusting the weights of segmentation network 220. As such, the training routine can then generate a loss function output based on at least the corrected image segmentation 221 and the training data 402. In specific examples, the segmentation network 220 can include a CNN with a set of filter values; and the trainer 400 can be configured to adjust the set of filter values in the convolutional neural network according to the loss function output.

In specific embodiments of the invention, a full set of training data for the user guided segmentation networks disclosed herein can be generated from a ground truth segmentation of an image. The training data set can be generated by a perturbation engine and a user input data synthesis engine. The ground truth segmentation can be either a hard mask or alpha mask of the image.

The perturbation engine can synthesize a failed segmentation, in the form of a distorted hard mask or alpha mask, using random processes. The perturbation can generate the failed segmentation by stochastically altering the values of the first mask in a border region of the ground truth segmentation to create the second mask. The stochastic process can involve the stochastic application or “grow in” or “grow out” distortion processes used in image editing. In the case of the first and second masks being alpha masks, the stochastic process can involve distorting the values of the alpha masks by a stochastic factor that is inversely proportional to a distance to a boundary of the ground truth segmentation. In other words, the maximum degree the values could be altered would be randomized by an amount whose expected maximum decreased with distance from the boundary of the ground truth segmentation. In the case of the first and second masks being hard masks, the stochastic process can involve inverting the values of the mask with a probability function with an expected value that is inversely proportional to a distance to a boundary of the ground truth segmentation. In other words, the probability of a value being inverted would decrease with distance from the boundary of the ground truth segmentation. The perturbation engine could also generate the failed segmentation by applying a blanket inversion of all pixels in the foreground or background of the ground truth segmentation. The perturbation engine could divide the original image into a set of sub-units, where the sub-units were equal in size to the input of the segmentation network. The perturbation engine could then find a boundary sub-unit in the set of sub-units where the boundary sub-unit included foreground pixels and background pixels. Then, the perturbation engine could change all of the pixels in the boundary sub-unit to either foreground or background pixel values. If the synthesized failed segmentation was to be an alpha mask, a similar operation could be conducted on the ground truth segmentation by setting all the values to one side of 0.5. The synthesis of the alpha mask in these cases could preserve the distribution of alpha values from the failed segmentation but distribute them from 0 to 0.5 or 0.5 to 1 instead of from 0 to 1. In the case of all pixels in a sub-unit being set to background or foreground, the synthesis engine could select one or the other for each sub-unit using a random process to guide the selection. The random processes and stochastic functions could be powered by a random number generator.

The user input synthesis engine can generate correction inputs from the ground truth segmentation alone, or along with the failed segmentation and/or the original image. The user input synthesis engine can be configured to generate the same types of correction inputs that are applied by the user to iterate the segmentations. For example, if the segmentation network was integrated with an image processing tool that accepted correction inputs in the form of marks drawn on the failed segmentation and original image, the user input synthesis engine could be configured to generate data that represented similar marks as drawn in the reference frame of the ground truth segmentation and/or synthesized failed segmentation. The marks could be lines, polygons, dots, scribbles, or any other kind of mark that can be made on a surface. Furthermore, the marks may contain other information besides their location relative to the image such as whether they are intended to mark foreground or background or in which direction the segmentation has failed. For example, the mark could include an arrow or indicate a direction via the manner in which they are drawn to indicate the direction in which the segmentation failed relative to where the mark is being made. As another, example a user could be allowed to mark foreground errors with a first color or input mode while marking background errors with a second color or input mode. As another example, the user could be asked to mark background errors and foreground errors using different kinds of marks such as circles or “B”s for background errors and “X”s or “F”s for foreground. Regardless of the kind of mark, the user correction synthesis engine can be used to produce similar marks using random processes and could be generated based on previously observed correction inputs, the ground truth segmentation, the failed segmentation, a delta between the ground truth segmentation and the failed segmentation, the original image, and any other factor.

In specific embodiments of the invention, a transform will be applied to a correction input before the correction input is applied to correct a segmentation. The portion of the correction input that is provided by a user can be referred to as the user marked correction input. The user marked correction input can be subjected to a blur or distance transform to produce the actual user correction input for use by the segmentation network to revise a failed segmentation. The transform can result in the generation of a set of activations in the reference frame of the original image that are related to the user input. As such, the user input synthesis engine can apply a similar transform in the process of synthesizing correction inputs for training the segmentation network. The transforms can produce numerical values in a pattern on the original image. In the case of distance transforms, the numerical values can increase monotonically outward from the proximate vicinity of the user marked correction input. The transforms can generate gradients in all directions from the user correction input or a single direction. The gradient can extent toward a border of the ground truth segmentation or away from the ground truth segmentation. Additionally, if multiple types of user marked correction inputs are provided then multiple types of transforms can be applied. For example, if a user marked correction input includes clicks on both sides of a desired segmentation border, the gradients can both be applied from the click towards the border.

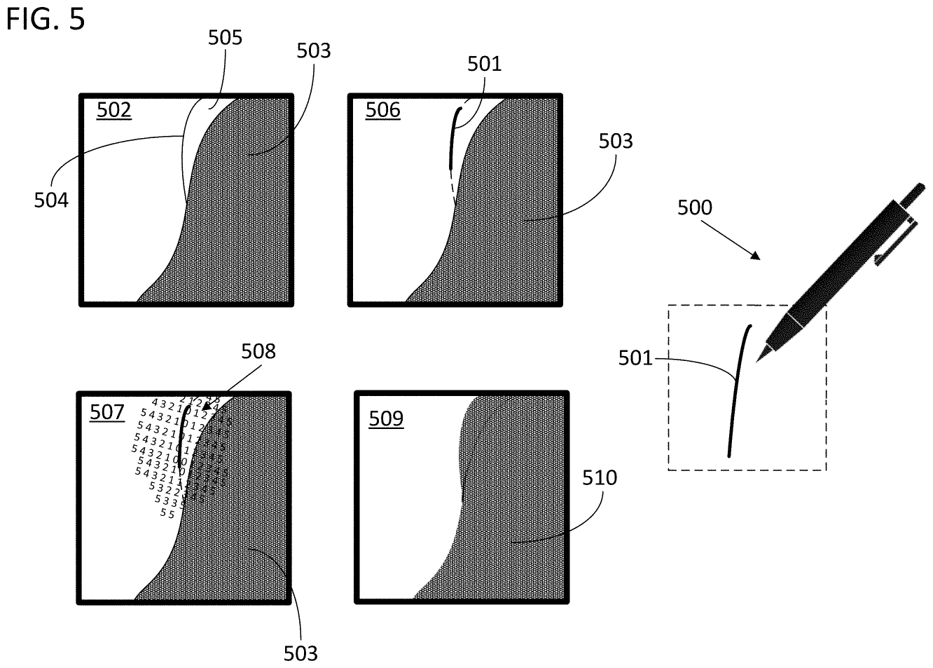

FIG. 5 provides an example of a transform for producing a set of activations for a user marked correction input in the form of a line 501 as provided by a digital pen 500. Image 502 shows a failed segmentation 503 along with a ground truth segmentation border 504. The failed segmentation has left a failed foreground segmentation region 505 that needs to be corrected via an iteration of user guidance. As shown in image 505, user marked correction input 501 can be generated using the ground truth segmentation and an analysis of the failed segmentation by selecting a portion of the ground truth segmentation border 504. Image 507 further shows how a distance transform can be applied to the mark. In the illustrated case, the distance transform is applied on either side of the line and increases monotonically from the mark. The resulting correction input is a field of activations 508 surrounding the line. These values could be applied along with the failed segmentation in a single input tensor to a segmentation network to generate a revised segmentation. Notably, the same approach could be used to produce a correction input from a user marked correction input provided by digital pen 500 to put the correction input into a more useful format for specific embodiments of the segmentation network.

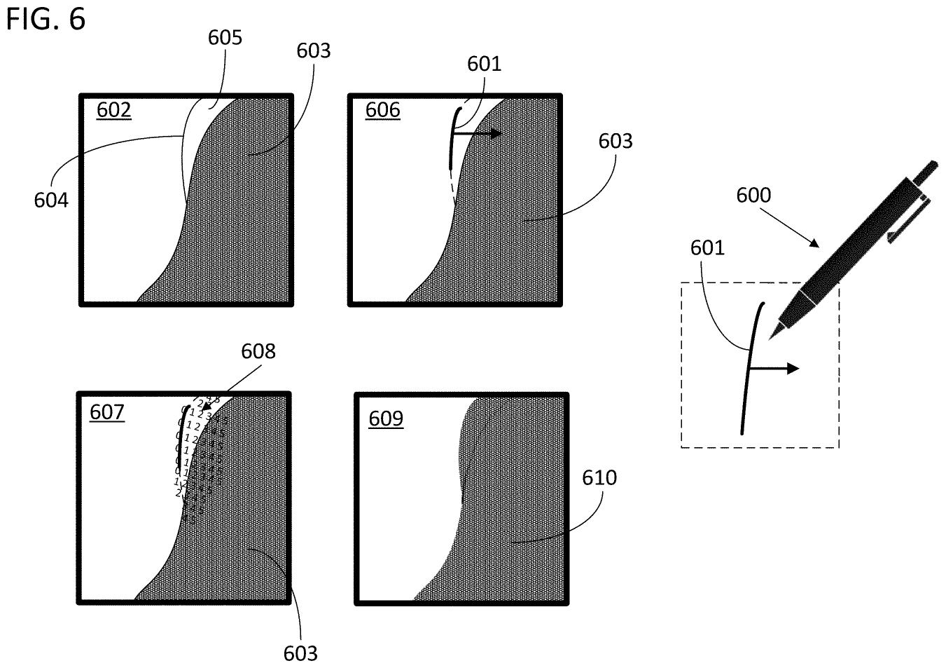

FIG. 6 provides an example of a transform for producing a set of activations for a user marked correction input in the form of a line and direction indicator 601 as provided by a digital pen 600. Image 602 shows a failed segmentation 603 along with a ground truth segmentation border 604. The failed segmentation has left a failed foreground segmentation region 605 that needs to be corrected via an iteration of user guidance. As shown in image 605, user marked correction input 601 can be generated using the ground truth segmentation and an analysis of the failed segmentation by selecting a portion of the ground truth segmentation border 604 and then synthesizing a direction input in the direction of the region to which the new line should be a boarder. Image 607 further shows how a distance transform can be applied to the mark. In the illustrated case, the distance transform is applied on only side of the line, increases monotonically from the mark, and is in the direction indicated by the direction input. The resulting correction input is a field of activations 608 on one side the line. These values could be applied along with the failed segmentation in a single input tensor to a segmentation network to generate a revised segmentation. Notably, the same approach could be used to produce a correction input from a user marked correction input provided by digital pen 600 to put the correction input into a more useful format for specific embodiments of the segmentation network.

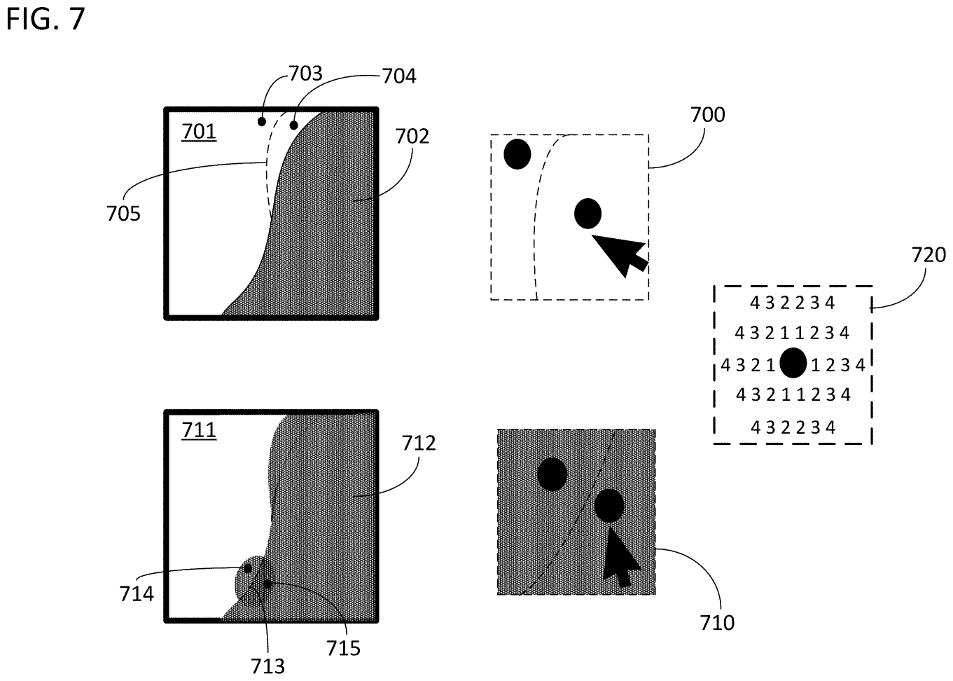

FIG. 7 provides an example of user marked correction inputs in the form of clicks point 700 and 710. The click points can be provided by taps on a touch display or clicks with a standard mouse. Image 701 shows how the marks could be points selecting a side of a border towards which the failed segmentation should be expanded 703 or points selecting a side of a boarder past which the failed segmentation should be expanded 704. Points 704 are placed within a delta of the failed segmentation and the ground truth segmentation. Points 703 are placed outside the desired boarder towards which the failed segmentation should be expanded. A distance transform 720 can be applied to either type of point to produce a field of activations. In image 701, boarder 705 indicates the ground truth segmentation boarder and segmentation 702 is the failed segmentation being corrected by the correction inputs. However, the network will treat the activations from either type of point differently so that the network can correct segmentation 702 using the two sets of activations. For example, one set of activations could be set negative with respect to the other set. In specific approaches, both types of points could be specified by the user and a distance transform could be applied to both sets to assist the network in finding the correct segmentation. Image 711 shows a similar situation in which failed segmentation 712 includes more foreground than ground truth, and user marked correction inputs are placed on either side of the ground truth border 713. In this approach, the two types of user marked correction inputs are those that select the over inclusive portion of the failed segmentation 714 or that mark the border towards which the failed segmentation should collapse 715. As with the prior example, the same values and gradient of the distance transform could be applied but the values could be treated differently by the segmentation network. In specific approaches, the activation values from one set of points could be set to negative. In any of these approaches, the values generated by the transform could be dot multiplied with the corresponding image or otherwise combined with the image values before being applied to the segmentation network.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, additional data can be combined with the input to the segmentation network such as depth information. Any of the method steps discussed above can be conducted by a processor operating with a computer-readable non-transitory medium storing instructions for those method steps. The computer-readable medium may be memory within a personal user device or a network accessible memory. Modifications and variations to the present invention may be practiced by those skilled in the art, without departing from the scope of the present invention, which is more particularly set forth in the appended claims.

What is claimed is:

1. A system comprising:
a display driver for displaying an image and an image segmentation on a display with the image segmentation overlaid on the image;
a user interface for accepting a correction input;
a segmentation network configured to: (i) accept the image segmentation and the correction input; and (ii) output a corrected segmentation from the image segmentation and the correction input; and
a trainer configured to: save the corrected segmentation, synthesize training data, and conduct a training routine for the segmentation network using the synthesized training data and the corrected segmentation.

2. The system of claim 1, wherein:
the training routine generates a loss function output based on at least the corrected image segmentation and the training data;
the segmentation network includes a convolutional neural network with a set of filter values; and
the trainer is configured to adjust the set of filter values in the convolutional neural network according to the loss function output.

3. The system of claim 2, wherein:
the trainer is configured to synthesize the training data using the image segmentation and the correction input; and
the trainer is configured to use the corrected segmentation as a supervisory output.

4. The system of claim 1, the trainer further comprises:
a perturbation engine configured to generate a synthesized failed segmentation using the corrected segmentation; and
a user input synthesis engine configured to generate a synthesized user correction using the synthesized failed segmentation; and
wherein the trainer is configured to use the corrected segmentation as a supervisory output and the synthesized failed segmentation and synthesized user correction as a corresponding input.

5. The system of claim 4, wherein the user input synthesis engine is configured to apply a distance transform to a synthesized user input to produce the correction input.

6. A method comprising:
displaying an image and an image segmentation on a display with the image segmentation overlaid on the image;
accepting a correction input from a user interface;
applying the image segmentation and the correction input to a segmentation network;
generating a corrected segmentation using the segmentation network based on the application of the image segmentation and the correction input to the segmentation network;
saving the corrected segmentation;
synthesizing training data for the segmentation network using the corrected segmentation, the image segmentation; and the correction input; and
training the segmentation network using the training data.

7. The method of claim 6, further comprising:
displaying the image and the corrected segmentation on the display with the corrected segmentation overlaid on the image;
accepting a second correction input from the user interface;
applying the corrected segmentation and the correction input to the segmentation network; and
generating a second corrected segmentation using the segmentation network and based on the application of the corrected segmentation and the correction input to the segmentation network.

8. The method of claim 6, further comprising:
combining the image segmentation and the correction input into a single tensor;
wherein the applying of the image segmentation and the correction input to the segmentation network consists essentially of applying the single tensor as an input to the segmentation network; and
wherein the segmentation network includes a convolutional neural network.

9. The method of claim 6, wherein training the segmentation network further comprises:
generating a loss function output based on at least the corrected image segmentation and the training data, the segmentation network including a convolutional neural network with a set of filter values; and
adjusting the set of filter values in the convolutional neural network according to the loss function output.

10. A computer-implemented method for training a segmentation network comprising:
providing a ground truth segmentation;
synthesizing a failed segmentation from the ground truth segmentation;
synthesizing a correction input for the failed segmentation using the ground truth segmentation; and
conducting a supervised training routine for the segmentation network using: (i) the failed segmentation and correction input as a segmentation network input; and (ii) the ground truth segmentation as a supervisory output.

11. The computer-implemented method from claim 10, wherein:
the synthesizing of the correction input for the failed segmentation also uses the failed segmentation.

12. The computer-implemented method from claim 10, wherein synthesizing the correction input comprises:
synthesizing a mark on a subject image of the ground truth segmentation; and
applying a distance transform to the mark.

13. The computer-implemented method from claim 12, wherein:
the mark is a line; and
the distance transform is applied on either side of the line; and
the correction input is a field of activations surrounding the line.

14. The computer-implemented method from claim 12, wherein:
the mark is a point; and
the point is located on the subject image within a delta between the ground truth segmentation and the failed segmentation; and
the correction input is a field of activations surrounding the point.

15. The computer-implemented method from claim 12, wherein:
the mark is a line and direction indicator;
the distance transform is applied on a side of the line, wherein the side is indicated by the direction indicator; and
the correction input is a field of activations on the side of the line.

16. The computer-implemented method from claim 10, wherein:
the ground truth segmentation is a first mask of an image;
the failed segmentation is a second mask of the image; and
synthesizing the failed segmentation consists essentially of stochastically altering the values of the first mask in a border region of the ground truth segmentation to create the second mask; and
the segmentation network includes a convolutional neural network.

17. The computer-implemented method from claim 16, wherein:
the first and second masks are both alpha masks of the image; and
stochastically altering the values includes distorting the values by a stochastic factor that is inversely proportional to a distance to a boundary of the ground truth segmentation.

18. The computer-implemented method from claim 16, wherein:
the first and second masks are both hard masks of the image; and
stochastically altering the values includes inverting the values with a probability function that is inversely proportional to a distance to a boundary of the ground truth segmentation.

19. The computer-implemented method from claim 11, wherein synthesizing the failed segmentation comprises:
perturbing a boundary of the ground truth segmentation using a random number generator.

20. The computer-implemented method from claim 11, wherein synthesizing the failed segmentation comprises:
breaking an image into a set of sub-units, the sub-units being equal to an input size of the segmentation network;
finding a boundary sub-unit in the set of sub-units, wherein the boundary sub-unit includes foreground pixels and background pixels; and
changing all segmentation values in the boundary sub-unit to one of foreground pixels and background pixels.
